(19) United States
(12) Patent Application Publication
(10) Pub. No.: US 2010/0142360 A1
(43) Pub. Date: Jun. 10, 2010

(54) BLU-RAY DISC MADE FROM DISCARDED CD OR DVD DISCS

(76) Inventor: John Matthew Town, Ojai, CA (US)

Correspondence Address: Robert D. Shedd, Patent Operations;THOMSON Licensing LLC, P.O. Box 5312, Princeton, NJ, 08543-5312, US

(21) Appl. No.: 12/733,196

(22) PCT Filed: Jan. 30, 2008
(86) PCT No.: PCT/US08/01194

§ 371 Date: Feb. 12, 2010

Related U.S. Application Data
(60) Provisional application No. 60/994,882, filed on Sep. 21, 2007.

(51) Int. Cl. G11B 7/24; B05D 3/12

(52) U.S. Cl. 369/275.1; 427/355; G9B/7.139

(57) ABSTRACT

Briefly, in accordance with one embodiment of the present principles, a Blu-ray disc is described. The Blu-ray disc has a structure including a substrate having one of either a Compact Dics data layer and a DVD data layer along with a Blu-ray data layer. The Blu-ray discs of the present invention advantageously use Compact Discs (or DVDs) that are due to be scrapped or recycled as donor substrates for new Blu-ray discs, thereby saving polycarbonate material and eliminating the need to purchase injection molding equipment to manufacture Blu-ray discs.

### CROSS REFERENCE TO RELATED APPLICATION

This application claims priority to and all benefits accruing from a provisional application filed in the United States Patent and Trademark Office on Sep. 21, 2007, and there assigned Ser. No. 60/994,882.

### TECHNICAL FIELD

This relates to a method for recycling Compact Discs (CDs) or Digital Video Discs (DVDs) that are due to be scrapped.

### BACKGROUND ART

Compact Discs often referred to as CDs, have proliferated greatly since their introduction in the 1970s. Indeed, the CD has become the medium of choice for hard copy delivery of music and software. Similarly, Digital Vide Discs (DVDs) have also proliferated and now serve as the medium of choice for hard copy distribution of audio visual programs, such as movies and television shows. Indeed disc replicators make millions of CDs and DVDs annually.

As with the manufacture of any product, the manufacture of CDs and DVDs results in some scrap. Heretofore, recycling of scrap CDs and DVDs has proven difficult because of the metallized layers within such discs. As a result, scrap discs are currently shredded, and remnants serve as filler for roads and highways. While some have experimented with using scrap paper for making new discs, none have attempted to recycle old discs to make new ones.

### BRIEF SUMMARY OF THE INVENTION

Briefly, in accordance with one embodiment of the present principles, a Blu-ray disc is described. The Blu-ray disc has a structure including a substrate having one of either a Compact Dics data layer and a DVD data layer along with a Blu-ray data layer. The Blu-ray discs of the present invention advantageously use Compact Discs (or DVDs) that are due to be scrapped or recycled as donor substrates for new Blu-ray discs, thereby saving polycarbonate material and eliminating the need to purchase injection molding equipment to manufacture Blu-ray discs.

### BRIEF DESCRIPTION OF THE DRAWINGS

FIG. 1 is a cross-sectional view of one embodiment of the Blu-ray disc of the present invention formed using a Compact Disc substrate;

FIG. 2 is a cross-sectional view of another embodiment of the Blu-ray disc of the present invention formed using a DVD substrate; and

FIG. 3 is a flow diagram depicting a method for forming the Blu-ray disc of the present invention.

### DETAILED DESCRIPTION

The present invention makes use of the fact that Blu-ray discs have the same dimensions and form factor as CDs and DVDs with the important feature on Blu-ray discs being that the data surface is on the bottom surface of the disc as opposed to CD which has the data surface on the top directly under the printed label, and DVDs where the data layers are in the center of the two bonded half-discs. The clear, flat bottom surface of CDs and DVDs lend themselves to the addition of a newly embossed Blu-ray data layer that supersedes the previous CD (DVD) data and effectively turns the CD (DVD) into a Blu-ray disc.

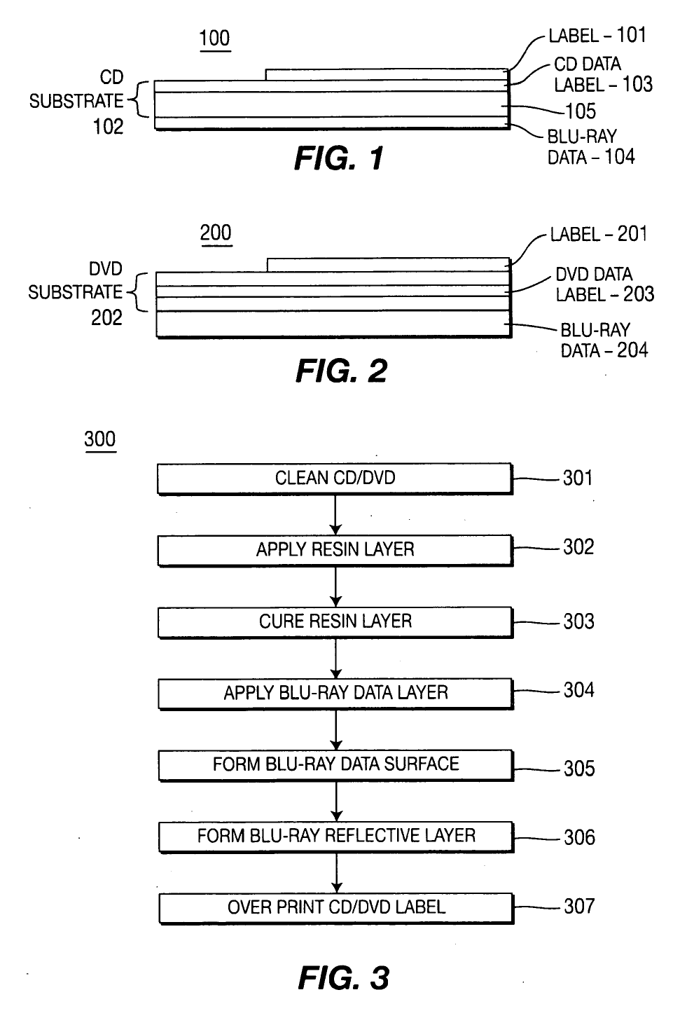

A CD disc structure is typically comprised of a CD (Compact Disc) data layer 103 formed on a plastic substrate 105 as shown in FIG. 1. The disc 100 of the present principles includes a Blu-ray data layer 104 formed on a surface of the plastic substrate 105 opposite the CD data layer 103. Such a structure provides a Blu-ray disc structure in which the CD data layer 103 may be ignored. Blu-ray data layer 104 may be formed of one or more layers of resin material (not shown). For example, a first resin layer may comprise a spacer layer formed directly on the CD substrate 105. A second resin layer may be formed on the first resin layer. The second resin layer typically contains the Blu-ray data surface.

Referring to FIG. 3 the method of manufacture for the Blu-ray disc 100 of the present principles is described. A discarded and/or unused CD substrate 105 having a CD data layer 103 formed thereon is cleaned as indicated in step 301.

Thereafter, referring to step 302, the cleaned CD substrate 105 may be coated on a surface opposite the CD layer 103 (read-through surface for laser) with a resin layer 104 as is used to make conventional Blu-ray disc via, for example, a wet-embossing process.

Resin layer 104 is then cured, as indicated in step 303 of FIG. 3. The resin layer 104 may be cured using for example, ultra-violet radiation. The cured resin 104 is then coated with a 1-10 micron thick layer of “pit resin” as used in conventional Blu-ray wet-embossing process. The “pit resin” is used to form the Blu-ray data surface of the Blu-ray disc 100, as indicated in step 304 of FIG. 3.

Referring to step 305 of FIG. 3, the pit-resin is embossed using a Blu-ray stamper and cured to form Blu-ray disc data surface. The embossing step replicates the Blu-ray data in the disc data surface. Thereafter, the curing step hardens the resin to prevent alteration of the replicated data.

After the Blu-ray data surface is formed in resin layer 104, this surface is metallized to form a reflective surface thereover as indicated in step 306 of FIG. 3. For a Blu-ray dual layer disc (not shown) steps 302-306.

Referring to step 307 of FIG. 3, a cover-layer and hardcoat are next applied to the Blu-ray disc structure as with conventional BD manufacturing process. Finally, the original CD (DVD) printed label 101 is coated with ink and overprint with a desired printed label for Blu-ray disc using conventional disc printing techniques.

A DVD disc structure is typically comprised of a DVD data layer 203 formed between two plastic substrates 202 as shown in FIG. 2. The disc 200 of the present principles includes a Blu-ray data layer 204 formed on a surface of the plastic substrate 202 opposite the DVD data layer 203. Such a structure provides a Blu-ray disc structure in which the DVD data layer 203 may be ignored.

Blu-ray data layer 204 may again be formed of one or more layers of resin material (not shown). For example, a first resin layer may comprise a spacer layer formed directly on the CD substrate 105. A second resin layer may be formed on the first resin layer. The second resin layer typically contains the Blu-ray data surface.

Referring to FIG. 3 the method of manufacture for the Blu-ray disc 200 of the present principles is described. A discarded and/or unused CD substrate 202 having a DVD data layer 203 formed thereon is cleaned as indicated in step 301.

Thereafter, referring to step 302, the cleaned DVD substrate 202 may be coated on a surface opposite the DVD layer 203 (read-through surface for laser) with a resin layer 204 as is used to make conventional Blu-ray disc via, for example, a wet-embossing process.

Resin layer 204 is then cured, as indicated in step 303 of FIG. 3. The resin layer 104 may be cured using for example, ultra-violet radiation. The cured resin 204 is then coated with a 1-10 micron thick layer of “pit resin” as used in conventional Blu-ray wet-embossing process. The “pit resin” is used to form the Blu-ray data surface of the Blu-ray disc 200, as indicated in step 304 of FIG. 3.

Referring to step 305 of FIG. 3, the pit-resin is embossed using a Blu-ray stamper and cured to form Blu-ray disc data surface. The embossing step replicates the Blu-ray data in the disc data surface. Thereafter, the curing step hardens the resin to prevent alteration of the replicated data.

After the Blu-ray data surface is formed in resin layer 204, this surface is metallized to form a reflective surface thereover as indicated in step 306 of FIG. 3. For a Blu-ray dual layer disc (not shown) steps 302-306.

Referring to step 307 of FIG. 3, a cover-layer and hardcoat are next applied to the Blu-ray disc structure as with conventional BD manufacturing process. Finally, the original DVD printed label 201 is coated with ink and overprint with a desired printed label for Blu-ray disc using conventional disc printing techniques.

The present invention makes use of the fact that Blu-ray discs have the same dimensions and form factor as CDs and DVDs with the important feature on Blu-ray discs being that the data surface is on the bottom surface of the disc as opposed to CD which has the data surface on the top directly under the printed label, and DVDs where the data layers are in the center of the two bonded half-discs. The clear, flat bottom surface of CDs and DVDs lend themselves to the addition of a newly embossed Blu-ray data layer that supersedes the previous CD (DVD) data and effectively turns the CD (DVD) into a Blu-ray disc. The manufacturing of such a disc would require no material changes limited to the glass master or disc recording stage.

The foregoing illustrates some of the possibilities for practicing the invention. Many other embodiments are possible within the scope and spirit of the invention. Therefore, it is intended that the foregoing description be regarded as illustrative rather than limiting, and that the scope of the invention is given by the appended claims together with their full range of equivalents.

1. An optical disc structure for playback by a read-out device, comprising
a substrate including one of a compact disc data layer and a digital video disc data layer along with a Blu-ray data layer.

2. The optical disc structure of claim 1 wherein the compact disc data is formed on a first surface of the substrate.

3. The optical disc structure of claim 2 wherein the Blu-ray data layer is formed on a second surface of the substrate.

4. The optical disc structure of claim 1 wherein the substrate comprises a first portion and a second portion.

5. The optical disc structure of claim 4 wherein the digital video disc data layer is formed between the first portion and the second portion.

6. The optical disc structure of claim 5 wherein the Blu-ray data layer is formed on an outer surface of the substrate.

7. A method of manufacturing an optical disc structure for playback by a read-out device, comprising:
forming a Blu-ray data layer on a substrate including one of a compact disc layer and a digital video disc data layer.

8. The method of claim 6 wherein the Blu-ray data layer is formed by embossing a resin layer formed on a surface of the substrate.
